(19) United States
(12) Patent Application Publication
(10) Pub. No.: US 2017/0022357 A1
(43) Pub. Date: Jan. 26, 2017

(54) BIODEGRADABLE COMPOSITION AND ARTICLE OF MANUFACTURE COMPRISING SAID COMPOSITION

(71) Applicant: Bradley W. Sokoly, Oviedo, FL (US)

(72) Inventor: Bradley W. Sokoly, Oviedo, FL (US)

(21) Appl. No.: 14/870,343

(22) Filed: Sep. 30, 2015

Related U.S. Application Data
(60) Provisional application No. 62/195,414, filed on Jul. 22, 2015.

(51) Int. Cl. C08L 67/04; A47G 19/22

(52) U.S. Cl. CPC C08L 67/04; A47G 19/2272

(57) ABSTRACT

The biodegradable composition may contain at least one plant-based solid and at least one bio-derived polymer. The plant-based solid(s) may contain about 50% to about 80% by weight of the biodegradable composition and the bio-derived polymer(s) comprise about 10% to about 30% by weight of the biodegradable composition. The composition may be used to make various articles of manufacture including but not limited to lids, caps, covers, and the like for containers, vessels, receptacles, etc.

### CLAIM OF PRIORITY

This application claims priority to U.S. application 62/195,414 which was filed on Jul. 22, 2015, the contents of which is herein fully incorporated by reference in its entirety.

### FIELD OF THE EMBODIMENTS

The field of the embodiments relate to a biodegradable composition and varying components and articles of manufacture made therefrom. In particular, the present invention relates to compositions comprising plant based matter formed into a lid for a vessel such as a drinking jar or glass.

### BACKGROUND OF THE EMBODIMENTS

Many consumers seek to reduce the amount of refuse they produce, or to reduce their “carbon footprint.” One way to reduce refuse and lower one's carbon footprint is to recycle and reuse items after their original intended use. In addition, recycling allows customers to save money and in some instances make money from centers that accept recycling donations of particular materials. The re-using of jars as drinking cups allows a customer to save both money and help reduce their carbon footprint.

Owing in part to the increase of the “green” market, and in response to the need for alternatives to the disposable cup or bottle, there has been growing interest in re-usable drinking cups. Aluminum and steel water bottles and drinking cups are not a practical alternative because such vessels cost considerably more than disposable cups. Canning jars have a widespread use in households worldwide and they are widely available. The most common class of canning jars is the ubiquitous “mason jar.” Different variations of mason jars have been used, and the term “mason jar” has now generally become a name synonymous for canning jars.

Single-use and disposable beverage container lids are known in the art. Commercially, these types of lids are typically constructed from conventional plastic materials effective for providing structural strength and rigidness, especially when used in connection with hot beverages like coffee and tea. Although popular, plastics are not typically regarded as biodegradable, resulting in beverage container lids that can take many decades to degrade following their commercial or general consumer use. In turn, lids made from more environmentally friendly alternative materials have been attempted, but met with tepid results.

Thus, it is desirable to have better ways to use jars and other containers for consuming beverages in order to use those jars and containers rather than adding them to refuse, and to save the cost of obtaining durable containers for beverage consumption. The present invention and its embodiments provides such technology by providing biodegradable material or composition that can be fashioned into various article of manufacture. In one embodiment this is manifested in lids that can turn a jar, or a range of other containers, receptacles, and the like into drinking cups. Review of related technology:

U.S. Patent Application 2013/0233898 pertains to lids for beverage containers and related methods, for example, a lid to fit within the screw on compression assembly found on standard canning jars to adapt the container to improve a user's ability to consume liquids directly from the vessel. Lids according to certain embodiments of the invention can be used with a wide range of containers like jars, so that the containers can be conveniently used to consume a beverage while avoiding spilling and facilitating extended use and recycling of the containers.

U.S. Patent Application 2010/0096395 pertains to a beverage container lid comprising a polymeric material and a pro-degradant additive in an amount from about 0.5% to about 5.0% by weight of the lid.

International Application 2009/137382 pertains to a biodegradable polymer composition useful for manufacturing biodegradable in which, the process comprises: 1) providing a renewable polymer and/or natural fiber, 2) providing a heat resistant polymer, 3)coextruding the heat-resistant polymer and the renewable polymer to provide a thermoformable composite comprising a core comprising the renewable polymer and/or natural fiber, wherein the renewable polymer and/or natural fiber comprises at least 50% by weight of the composite and a heat-resistant outer layer comprising the heat-resistant polymer which substantially surrounds the core.

Various devices are known in the art. However, their structure and means of operation are substantially different from the present disclosure. The other inventions fail to solve all the problems taught by the present disclosure. The present invention provides a biodegradable composition that may take varying forms. In one form factor, the composition comprises a reusable drinking lid to be used with hot and/or cold beverages. At least one embodiment of this invention is presented in the drawings below and will be described in more detail herein.

### Summary of the Embodiments

Generally, the present invention and its embodiments provide for a biodegradable composition and articles of manufacture formed from the aforementioned composition. The composition is intended to comprise plant based solids and various polymers to provide a sturdy material that will quickly breakdown once ready to be discarded. The material may be molded into the form of a drinking lid having a spout and a rim. The design of the lid is to be ergonomic and facilitate drinking from a container such as a mason-style jar or other receptacle. A gasket may be employed to help create a liquid impermeable seal between the receptacle and the drinking lid.

In an embodiment of the present invention there is a biodegradable composition comprising: at least one plant-based solid; and at least one bio-derived polymer; wherein the at least one plant-based solid comprises about 50% to about 80% by weight of the biodegradable composition and the at least one bio-derived polymer comprises about 10% to about 30% by weight of the biodegradable composition.

In another embodiment of the present invention there is a biodegradable composition comprising: about 50% to about 60% by weight of bamboo powder; about 15% to about 20% by weight of a polylactic acid resin; about 5% to about 10% of cornstarch; about 4% to about 10% of a bran coat; about 2% to about 8% of water; and about 0.3% to about 2% of pigment.

In another embodiment of the present invention there is a drinking lid being comprised of a biodegradable composition as described in herein and sized to fit partially within and cover an opening of a receptacle, the drinking lid comprising: a lid member having a first opening and a second opening with the first opening having a smaller diameter than the second opening; and a coupling member extending downwards from the lid member, the coupling member having a recess extending around an outer perimeter of the coupling member, wherein the coupling member is sized to engage an inner surface of the receptacle.

In general, the present invention succeeds in conferring the following, and others not mentioned, benefits and objectives.

It is an object of the present invention to provide a biodegradable material that takes the form of a drinking lid.

It is an object of the present invention to provide a biodegradable material that comprises plant solids.

It is an object of the present invention to provide a drinking lid that is lightweight and inexpensive.

It is an object of the present invention to provide a drinking lid that fits onto and is retained by a mason-style jar.

It is an object of the present invention to provide a drinking lid that can be utilized with both hot and cold beverages.

It is an object of the present invention to provide a drinking lid that is ergonomically beneficial to the user.

It is an object of the present invention to provide a drinking lid that prevents seepage of a beverage from a beverage container while utilizing the drinking lid.

It is an object of the present invention to provide a drinking lid that is reusable.

### BRIEF DESCRIPTION OF THE DRAWINGS

FIG. 1 is a perspective view of an article of manufacture comprising the biodegradable material.

FIG. 2 is a first side view of an article of manufacture comprising the biodegradable material.

FIG. 3 is a second side view of an article of manufacture comprising the biodegradable material.

FIG. 4 is a third side view of an article of manufacture comprising the biodegradable material.

FIG. 5 is a fourth side view of an article of manufacture comprising the biodegradable material.

FIG. 6 is a top view of an article of manufacture comprising the biodegradable material.

FIG. 7 is a bottom view of an article of manufacture comprising the biodegradable material.

FIG. 8 is a perspective view of an article of manufacture comprising the biodegradable material with a sealing gasket positioned there around.

FIG. 9 is a side view of the present invention embodied as a lid for a drinking jar.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

For the purposes of the present invention and its embodiments, the term “plant-based solid” refers to fibers, powders, pellets, pieces (whole or crushed or otherwise) being in a hydrous or anhydrous form that comprises one or more material derived from a plant including but not limited to seeds, husks, stems, flowers, roots, stalks, branches, trunks, barks, or leaves or the like.

For the purposes of the present invention and its embodiments, the term “poly lactic acid or polylactic acid or polylactide (collectively PLA)” refers to a renewable, biodegradable, thermoplastic, aliphatic polyester formed from a lactic acid or a source of lactic acid, for example, renewable resources such as corn starch, sugarcane, etc. The term PLA may refer to all stereoisomeric forms of PLA including L- or D-lactides, and racemic mixtures comprising L- and D-lactides. For example, PLA may include D-polylactic acid, L-polylactic acid (also known as PLLA), D,L-polylactic acid, meso-polylactic acid, as well as any combination of D-polylactic acid, L-polylactic acid, D,L-polylactic acid and meso-polylactic acid. PLAs useful herein may have, for example, an average molecular weight in the range of from about 15,000 Da to about 300,000 Da. In preparing PLA, bacterial fermentation may be used to produce lactic acid, which may be oligomerized and then catalytically dimerized to provide the monomer for ring-opening polymerization. PLA may be prepared in a high molecular weight form through ring-opening polymerization of the monomer using, for example, a stannous octanoate catalyst, tin (II) chloride, etc.

For the purposes of the present invention and its embodiments, the term “molded” or “molding” refers to any method for casting, shaping, forming, extruding, etc., softened or melted polymers, layers, composites, etc., of the present invention and its embodiments.

For the purposes of the present invention and its embodiments, the term “compression molded” or “compression molding” refers to a method of molding in which the molding material, with optional preheating, is first placed in an open, heated mold cavity. The mold is closed with a top force or plug member, pressure is applied to force the material into contact with all mold areas, and heat and pressure are maintained until the molding material has cured.

For the purposes of the present invention and its embodiments, the term “mason jar” or “Ball® jar” or “canning jar” or “glass canning jar” or “mason-style jar” refers in part to jars originally invented and patented by John Mason. More generally, the term may refer to jars used for canning, drinking, and storage of items that have a screw thread or other means of coupling a lid thereto that creates a hermetic seal with respect to the contents held within the jar. The mason jar may come in various sizes and configurations including but not limited to those having a “regular mouth” jar opening and a “wide mouth” jar opening. The regular mouth opening has about a 2⅜ in (60 mm) inner diameter and about a 2¾ in (70 mm) outer diameter. The wide mouth opening has about a 3 in (76 mm) inner diameter and about a 3⅜ in (86 mm) outer diameter. The volumes of the jar(s) may include but are not limited to cup or half-pint, pint, quart, and half-gallon. The mason jar may or may not have a handle or other apparatus to facilitate handling of the mason jar.

At least one embodiment of a biodegradable composition of the present invention is described in the table below.

TABLE 1

| Ingredient | Proportion range (%) |
|---|---|
| Bamboo powder | 55% |
| PLA resin | 20% |
| Cornstarch | 10% |
| Bran coat | 8% |
| Water | 6% |
| Food grade water-based paint | 0.8% |
| (polyurethane paint) | |
| Toner | 0.5% |

As shown above, the plant-based solids (bamboo powder, corn starch, and bran coat) in this particular embodiment comprise about 73% by weight of the biodegradable composition and the at least one bio-derived polymer (PLA) comprises about 20% by weight of the biodegradable composition. With regard to the plant-based solids, other plant-based solids may be used from the same or different plant sources and may appear in different proportions that shown in the table above. In some instances only one type of plant-based solid is used, whereas in others five or more different solids are used in the same composition. The bio-derived polymer may or may not be PLA and may be any bio-derived polymer that is non-petroleum based. Generally, the plant-based solids may comprise about 50% to about 80% by weight of the composition and the bio-derived polymer may comprise about 10% to 30% by weight of the composition.

The composition may also generally contain water, about 2% to about 15% by weight, and pigments (food grade paint/toner), about 0.1% to about 5% by weight, for creating a slurry, that once cured, will create a desired color configuration in the article of manufacture bearing the composition. In some embodiments, the composition may remain uncolored and can be later screen printed or having other designs applied thereto for enhancing the aesthetic appearance of the composition.

The article of manufacture may be created using a molding or compression molding technique that is used to cure the composition to a rigid structure suitable for use for commercial, industrial, and/or personal use. In some embodiments, the mold is preheated before adding the biodegradable composition to a temperature of about 120° F. to about 180° F. Once the slurry containing all desired materials of the composition (preferably mixed thoroughly for homogeneity) is added the temperature and pressure contained within the mold is increased causing the slurry to harden or cure into the desired mold shape.

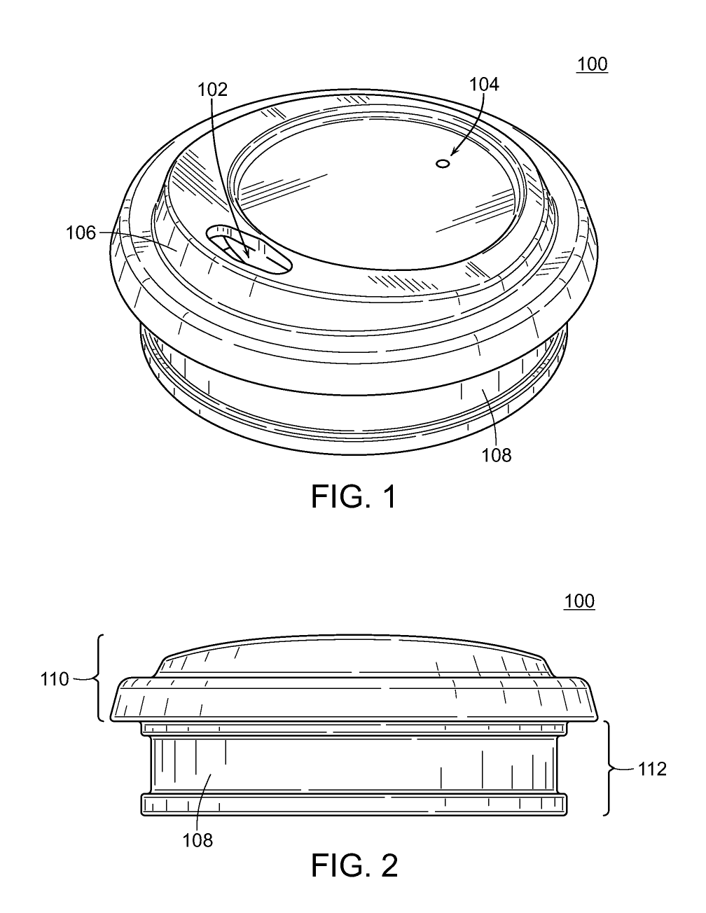

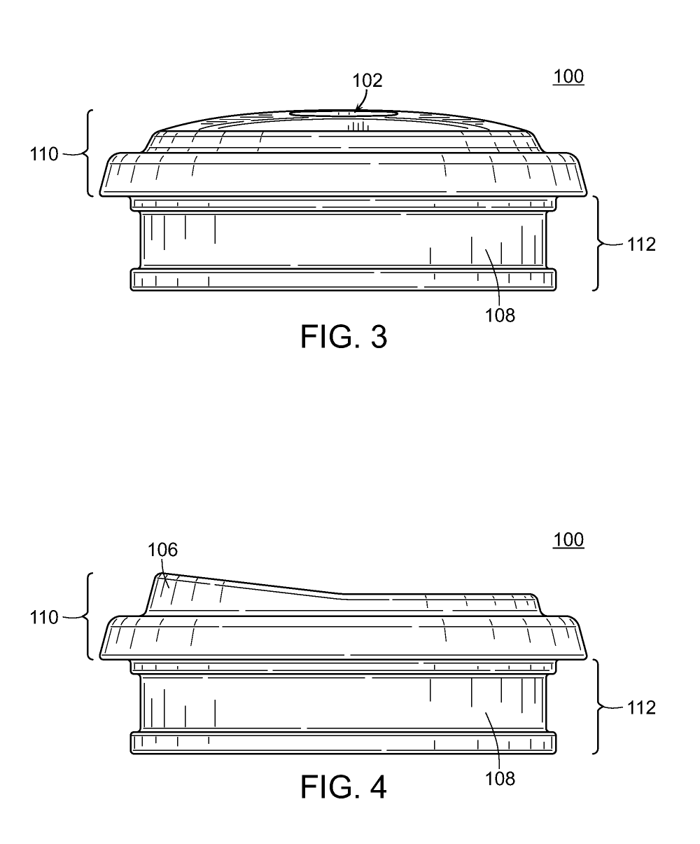

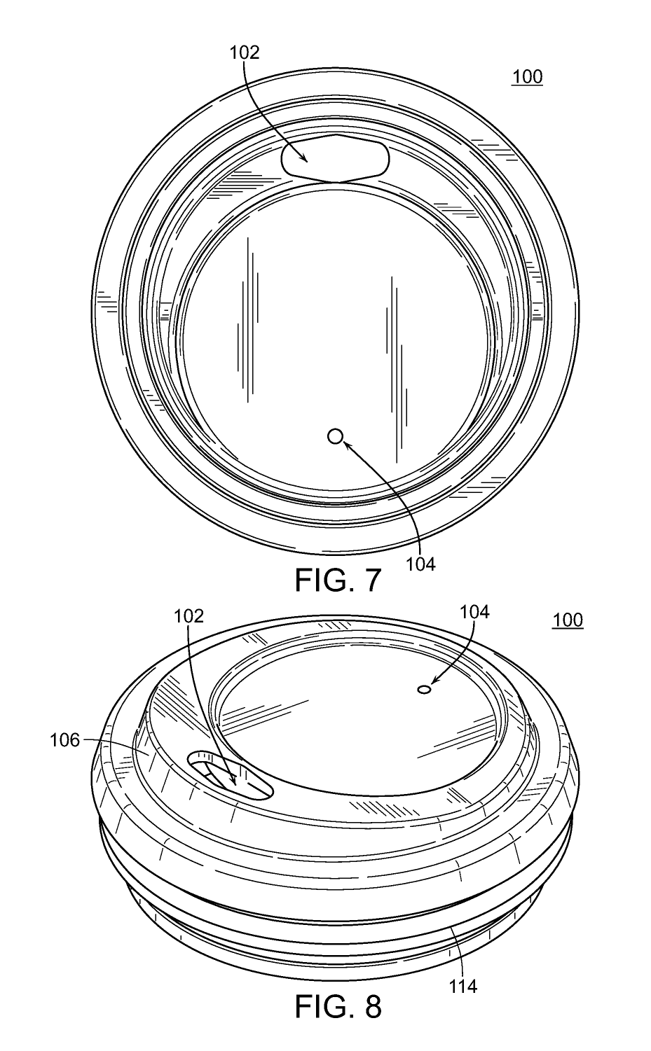

Referring to FIGS. 1-8, there is an embodiment of the present invention as an article of manufacture, in this case a drinking lid 100. The drinking lid 100 is preferably comprised of an embodiment of a biodegradable composition as described previously herein and is sized to fit partially within and cover an opening of a receptacle. The drinking lid 100 generally has a lid member 110, a first opening 104, a second opening 102, a raised spout 106, a recess 108, and a coupling member 112. In some embodiments, the coupling member 112 or recess 108 is fitted with a gasket 114 (see FIG. 8).

The lid member 110 may comprise the first opening 104, second opening, 102, and the raised spout 106 thereon. In some embodiments, the first opening 104 has a smaller diameter than the second opening 102. In other embodiments the first opening 104 has a larger diameter than the second opening 102. Preferably, the second opening 102 is disposed on the raised spout 106 whereas the first opening 104 resides on and through an upper surface of the lid member 110. The first opening 104 is primarily intended to allow air to move in and out of the beverage receptacle thereby allowing for a consistent and even flow of the beverage contained therein.

The coupling member 112 extends downwards from the lid member 110. In some embodiments, the angle formed between the coupling member 112 and the lid member 110 is about 90°. However, the angle formed may vary depending the receptacle the drinking lid 100 is intended to be coupled. The combination of the beverage receptacle and gasket 114 (see FIG. 8) may be such that it enables the gasket 114 to create a fluid seal with the beverage receptacle. The coupling member 112 has a recess 108 extending around an outer perimeter of the coupling member.

In some embodiments, as shown in FIG. 8, a gasket 114 is used to prevent spillage or seepage of the material, preferably liquid, contained within the receptacle by forming a fluid seal with the inner surface of the receptacle. This may be achieved in part due to the construction of the gasket 114. The gasket 114 may have a flat band and a seal member emanating generally perpendicularly therefrom. The flat band provides support for the gasket 114, when positioned in the recess 108, whereas the seal member interfaces with the inner surface of the receptacle. The lid member 110 is further designed to overlap or extend over the opening of the receptacle thereby providing additional sealing mechanisms. The gasket 114 may be a rubber, silicone, plastic, composite, and the like or any combination thereof. The gasket 114 may or may not be biodegradable. If biodegradable, it is preferable that the gasket 114 is comprised of PLA with various additives including plasticizers to provide flexibility for ease of use and to prevent breakage during use.

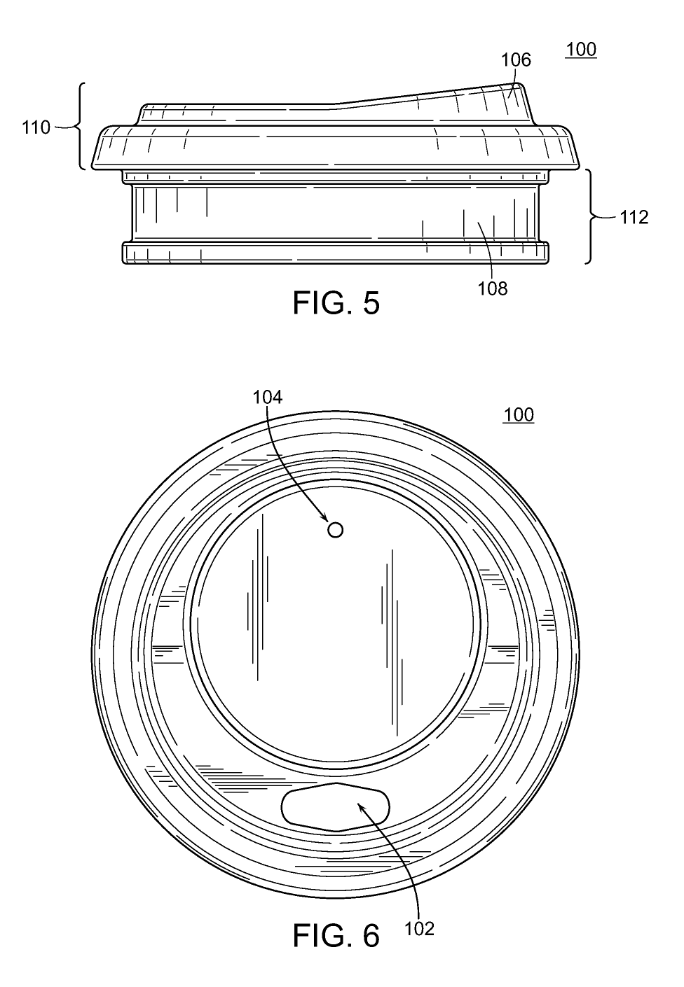

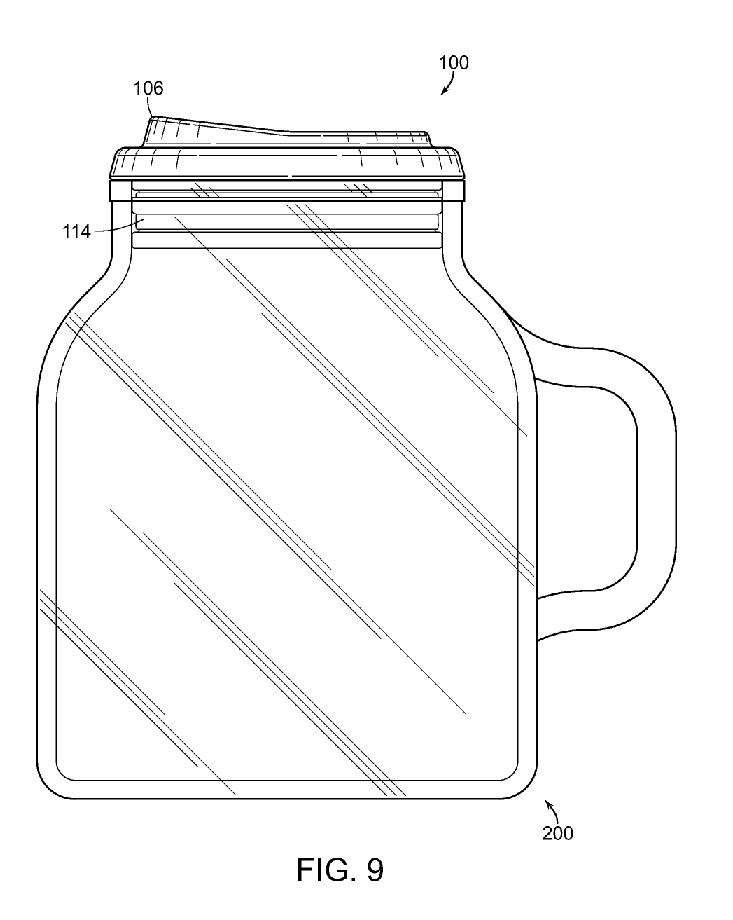

Referring now to FIG. 9, the drinking lid 100 is sized to fit a mason style jar 200, whereas in other embodiments other jars, containers, vessels, receptacles, and the like are used to size the drinking lid 100. The mason style jar 200 has an opening and a receiving area for receiving a weight or volume of material preferably a food product. The drinking lid 100 is pressed downward into the opening of the mason style jar 200. The lid member 110 (see FIG. 5) is intended, in at least one embodiment, to reside on an upper surface of the jar surrounding the opening.

Once in place, the drinking lid 100 may be capable of being rotated to align the raised spout 106 to a preferred orientation around the circumference of the mason style jar 200. The gasket 114 may have a flat band and a seal member emanating generally perpendicularly therefrom. As shown in FIG. 9, the gasket 114 or seal member abuts the inner surface of the mason style jar 200. This creates a fluid seal between the gasket 114 and the mason style jar 200. Further, the lid member serves to act as a secondary fluid seal. In sum, the drinking lid 100 effectively prevents spillage, seepage, or the like stemming from the drinking lid 100 falling from the mason style jar 200 opening or during the course of use.

In yet other embodiments, other articles of manufacture may comprise the biodegradable composition contained herein including but not limited to containers, writing instruments, holders, clips, trays, chairs, thumb drives, and the like. Virtually any classification of good may incorporate the biodegradable material to some degree.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A biodegradable composition comprising:
at least one plant-based solid; and
at least one bio-derived polymer;
wherein the at least one plant-based solid comprises about 50% to about 80% by weight of the biodegradable composition and the at least one bio-derived polymer comprises about 10% to about 30% by weight of the biodegradable composition.

2. The biodegradable composition of claim 1 further comprising at least one pigment.

3. The biodegradable composition of claim 1 further comprising water.

4. The biodegradable composition of claim 1 wherein the at least one plant-based solid is a fiber and/or powder of cellulose, wood, rice, wheat bran, straw, corn, bamboo, or a combination thereof.

5. The biodegradable composition of claim 4 wherein a mixture of the bamboo and the wheat bran comprise the at least one plant based solid.

6. The biodegradable composition of claim 5 wherein the ratio of bamboo to wheat bran is approximately 7:1.

7. The biodegradable composition of claim 1 wherein the at least one bio-derived polymer is polylactic acid.

8. The biodegradable composition of claim 2 wherein the at least one pigment is a water-based paint and/or toner.

9. A biodegradable composition comprising:
about 50% to about 60% by weight of bamboo powder;
about 15% to about 20% by weight of a polylactic acid resin;
about 5% to about 10% of cornstarch;
about 4% to about 10% of a bran coat;
about 2% to about 8% of water; and
about 0.3% to about 2% of pigment.

10. The biodegradable composition of claim 9 wherein the bamboo comprises about 55% by weight of the composition and the polylactic resin comprises about 20% by weight of the composition.

11. The biodegradable composition of claim 9 wherein the pigment comprises a water-based paint and toner.

12. A drinking lid being comprised of a biodegradable composition and sized to fit partially within and cover an opening of a receptacle, the drinking lid comprising:
a lid member comprising a composition of claim 1, the lid member having a first opening and a second opening with the first opening having a smaller diameter than the second opening; and
a coupling member comprising a composition of claim 1, the coupling member extending downwards from the lid member, the coupling member having a recess extending around an outer perimeter of the coupling member with a gasket disposed in and retained by the recess,
wherein the coupling member and gasket combination is sized to engage an inner surface of the receptacle.

13. The drinking lid of claim 12 further comprising a raised spout disposed on an upper surface of the lid member,
wherein the second opening is disposed on the raised spout.

14. The drinking lid of claim 12 wherein the lid member has a diameter greater than that of the coupling member.

15. The drinking lid of claim 12 wherein the receptacle is a mason jar.

16. The drinking lid of claim 13 wherein the gasket forms a fluid seal with an inner wall of the receptacle.

17. The drinking lid of claim 12 wherein the receptacle contains a hot or cold beverage.
